(19) United States
(12) Patent Application Publication
(10) Pub. No.: US 2025/0141285 A1
(43) Pub. Date: May 1, 2025

(54) MOTOR STRUCTURE

(71) Applicants: HYUNDAI MOTOR COMPANY, Seoul (KR); KIA CORPORATION, Seoul (KR)

(72) Inventors: Min Ho Chae, Incheon (KR); Ho Jun Shin, Siheung-si (KR)

(73) Assignees: HYUNDAI MOTOR COMPANY, Seoul (KR); KIA CORPORATION, Seoul (KR)

(21) Appl. No.: 18/614,204

(22) Filed: Mar. 22, 2024

(30) Foreign Application Priority Data
Oct. 31, 2023 (KR) 10-2023-0148289

(51) Int. Cl. H02K 1/276

(52) U.S. Cl. CPC H02K 1/276

(57) ABSTRACT

A motor structure includes a rotor core, a permanent magnet inserted into the rotor core, and a retainer installed to support the permanent magnet in a radial direction of a rotor core.

### CROSS REFERENCE TO RELATED APPLICATIONS

The present application claims priority to Korean Patent Application No. 10-2023-0148289, filed Oct. 31, 2023, the entire contents of which are incorporated herein for all purposes by this reference.

### BACKGROUND

### 1. Technical Field

The present disclosure relates to a motor structure that improves torque density in a motor.

### 2. Description of the Related Art

Electric vehicles are driven by generating torque with an installed motor. Thus, the higher torque density of a motor, the better the power performance of a vehicle and fuel efficiency.

Motors mounted on electric vehicles are generally of the permanent magnet embedded type. Depending on the state of permanent magnets embedded in a rotor, the amount of magnetic flux leakage varies. In order to improve torque density of a motor, it is necessary to reduce the amount of magnetic flux leakage as much as possible.

The description provided above as related art of the present disclosure is just to help understand the background of the present disclosure and should not be construed as being included in the related art known by those of ordinary skill in the art.

### SUMMARY

The present disclosure is proposed to solve the above problems. The present disclosure is intended to provide a motor structure that reduces magnetic flux leakage of a rotor with embedded permanent magnets and that improves torque density of a motor.

The technical problems of the present disclosure are not limited to those mentioned above. Other problems not mentioned herein should be more clearly understood by those of ordinary skill in the art from the description below.

In order to achieve the objectives of the present disclosure, a motor structure is provided. The motor structure includes a rotor core, a permanent magnet inserted into the rotor core, and a retainer installed to support the permanent magnet in a radial direction of a rotor core.

The permanent magnet may be provided with a protruding end portion that protrudes from the rotor core. The retainer may be installed to restrain and support the protruding end portion of the permanent magnet.

A protruding end portion of the permanent magnet may be formed to protrude from each end of the rotor core in an axial direction. A retainer may be provided at each end of the rotor core in the axial direction.

The retainer may be provided with a disk-shaped disk portion having a plurality of insertion portions into which the protruding end portion of the permanent magnet may be installed.

The insertion portions of the disk portion may be provided in a form of insertion holes penetrating the disk portion.

The insertion portions of the disk portion may be provided in a form of insertion grooves that are locally recessed in the disk portion.

In the disk portion of the retainer, the insertion portions may be provided at positions such that centrifugal forces of a plurality of permanent magnets provided in the rotor core cancel each other out.

In order to achieve the objectives of the present disclosure, a motor structure includes: a stator; a rotor core rotatably inserted into the stator; a plurality of permanent magnets inserted parallel to a rotation axis of the rotor core; and a retainer that secures an end of the rotor core from which the permanent magnets protrude.

The retainer may be formed to restrain the permanent magnets from moving in a radial direction with respect to the rotor core.

The permanent magnets may be disposed along a circumferential direction of the rotor core. The retainer may be provided in a disk shape such that end portions of the permanent magnets are inserted at an end of the rotor core.

The permanent magnets may be inserted so as to protrude from opposite ends of the rotor core. A retainer may be installed at each end of the rotor core.

The retainer may be provided with a plurality of insertion holes into which the end portions of the permanent magnets are inserted.

The retainer may be provided with a plurality of insertion grooves on a surface facing the rotor core into which the end portions of the permanent magnets are inserted.

In the retainer, the end portions of the permanent magnets may be inserted into insertion portions provided in the retainer at positions symmetrical to each other about the rotation axis of the rotor core to cancel out centrifugal forces of the permanent magnets provided in the rotor core.

The present disclosure effectively reduces magnetic flux leakage of a rotor in which permanent magnets are embedded. Torque density of a motor is thereby improved and sufficient durability of the motor is thereby ensured.

The effect of the present disclosure is not limited to that described above. Other effects not mentioned herein should be more clearly understood by those of ordinary skill in the art from the description below.

### BRIEF DESCRIPTION OF THE DRAWINGS

FIG. 1 is a view showing a motor structure according to the present disclosure;

FIG. 2 is view showing a state in which a retainer in FIG. 1 is removed;

FIG. 3 is a view showing a rotor core and a permanent magnet;

FIG. 4 is a cross-sectional view taken along line IV-IV of the rotor core and permanent magnet of FIG. 3; and

FIG. 5 is a cross-sectional view taken along line V-V of the motor structure of FIG. 1.

### DETAILED DESCRIPTION

Hereafter, embodiments of the present disclosure are described in detail with reference to the accompanying drawings. The same or similar components are given the same reference numerals throughout the drawings and are not repeatedly described for each drawing.

Terms such as “module” and “unit” that are used for components in the following description are used only for the convenience of description without having discriminate meanings or functions.

In the following description, where it has been decided that the detailed description of known technologies related to the present disclosure would have made the subject matter of the embodiment described herein unclear, the detailed description for such technologies has been omitted. Furthermore, the accompanying drawings are provided only to aid in understanding the embodiments disclosed in the specification. The technical spirit disclosed in the specification is not limited by the accompanying drawings. All changes to, equivalents of, and replacements for the disclosed embodiments should be understood as being included in the spirit and scope of the present disclosure.

Terms including ordinal numbers such as “first”, “second”, etc. may be used to describe various components, but the components are not to be construed as being limited by the terms. The terms are used only to distinguish one component from another component.

It is to be understood that, when one element is referred to as being “connected to” or “coupled to” another element, the one element may be connected directly to or coupled directly to another element or may be connected to or coupled to another element, having yet another element intervening therebetween. On the other hand, it should to be understood that, when one element is referred to as being “connected directly to” or “coupled directly to” another element, the one element may be connected to or coupled to another element without any element intervening therebetween.

Singular forms are intended to include plural forms unless the context clearly indicates otherwise. When a component, device, element, or the like of the present disclosure is described as having a purpose or performing an operation, function, or the like, the component, device, or element should be considered herein as being “configured to” meet that purpose or to perform that operation or function.

It should be further understood that the terms “comprise”, “include”, or “have” or variations thereof used in this specification, specify the presence of stated features, steps, operations, components, parts, or a combination thereof. These terms do not preclude the presence or addition of one or more other features, numerals, steps, operations, components, parts, or a combination thereof.

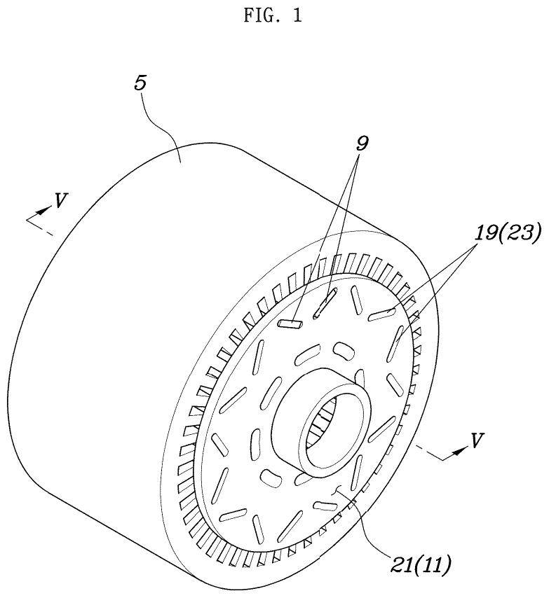

FIG. 1 is a view showing a motor structure according to the present disclosure. FIG. 1 shows a stator core 5 in which a coil 1 is wound to form a stator 3, a permanent magnet 9 constituting a rotor 7, and a retainer 11 that restrains the permanent magnet 9.

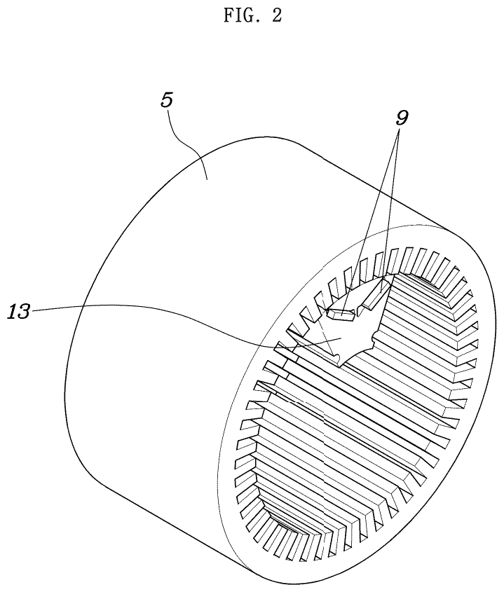

FIG. 2 is view showing a state in which the retainer 11 in FIG. 1 is removed. FIG. 2 shows the structure of a rotor core 13 constituting the rotor 7 and the permanent magnet 9 inserted therein. The portion shown corresponds to one eighth (⅛) of the entire rotor 7.

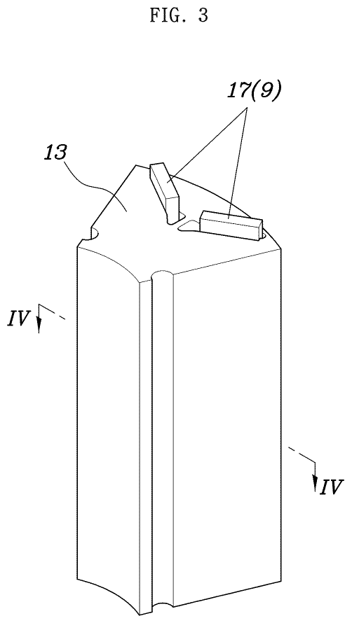

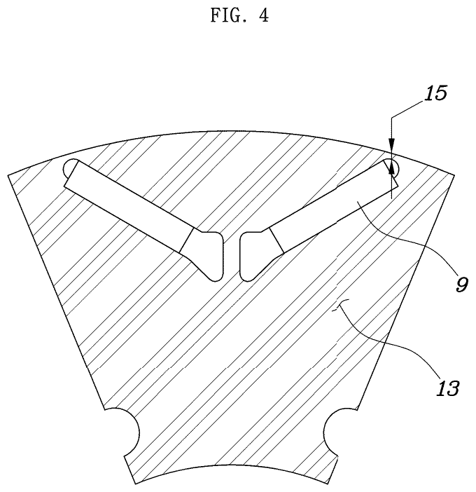

FIG. 3 shows the rotor core 13 and the permanent magnet 9 of FIG. 2 from a different angle. FIG. 4 is a cross-sectional view taken along line IV-IV of the rotor core 13 of FIG. 3.

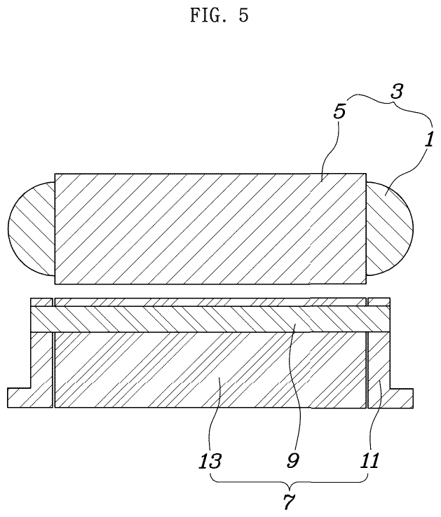

FIG. 5 is a cross-sectional view taken along line V-V of the motor structure of FIG. 1. In FIG. 5, the coil 1 is shown wound on the stator core 5.

Referring to FIGS. 1-5, a motor structure according to an embodiment of the present disclosure is shown. The motor structure includes the rotor core 13, the permanent magnet 9 inserted into the rotor core 13, and the retainer 11 installed to support the permanent magnet 9 in the radial direction of the rotor core 13.

The stator core 5 constituting the stator 3 is provided outside the rotor core 13. The coil 1 for creating a magnetic field is wound around the stator core 5.

In other words, a motor of the present disclosure is composed of: the stator 3 consisting of the stator core 5 and the coil 1; and the rotor consisting of the rotor core 13, the permanent magnet 9, and the retainer 11. The permanent magnet 9 s inserted into the rotor core 13 and is configured such that the movement thereof in the radial direction of the rotor core 13 is restrained by the retainer 11.

A rib 15 between the permanent magnet 9 and the outer peripheral surface of the rotor core 13 is made as thin as possible. As the retainer 11 stably restrains the permanent magnet 9 against the centrifugal force caused by the rotation of the rotor 7, the stable embedded state of the permanent magnet 9 in the rotor core 13 is continuously maintained. Thus, the durability required for the rotor 7 may be ensured. In addition, due to the thinner rib 15 as described above, magnetic flux leakage of the rotor 7 is reduced, ultimately improving torque density of the motor.

In other words, the present disclosure maximizes the effect of reducing magnetic flux leakage by reducing the thickness of the rib 15 of the rotor core 13. This is achieved while allowing the retainer 11 to effectively restrain the radial movement of the permanent magnet 9. Thus, the structural durability required rotor for the 7 is sufficiently secured.

The permanent magnet 9 is provided with a first protruding end portion 17 at a first end that protrudes from the rotor core 13 at one end. The retainer 11 may be considered as a first retainer 11, installed to restrain and support the first protruding end portion 17 of the permanent magnet 9.

A protruding end portion 17, i.e., first and second protruding end portions 17, of the permanent magnet 9 may be formed to protrude from each end, i.e., one end and an opposite end, of the rotor core 13 in the axial direction. The retainer 11, i.e., first and second retainers 11 may be provided, respectively, at each end of the rotor core 13 in the axial direction.

The retainers 11 restrain the permanent magnets 9 from moving outward in the radial direction of the rotor core 13 on opposite sides of the rotor core 13 due to the centrifugal force generated as the rotor 7 rotates. The retainers 11 thus firmly support the permanent magnets 9. Thus, the rib 15 of the rotor core 13 may be made thinner, which has the effect of reducing the magnetic flux leakage of the rotor 7.

In one embodiment, each retainer 11 has a disk-shaped disk portion 21 with a plurality of insertion portions 19 into which the corresponding protruding end portion 17 of a permanent magnet 9 is inserted.

In one embodiment, a plurality of the permanent magnets 9 are arranged in a predetermined pattern along the circumferential direction of the rotor core 13. In the disk portion 21 of the retainer 11 as described above, the centrifugal forces acting on the permanent magnets 9 act symmetrically about the rotation axis of the rotor core 13 and cancel each other out.

Accordingly, the rotation axes of the rotor core 13 and the retainer 11 continuously maintain a concentric state, preventing unnecessary vibration from occurring.

Each of the insertion portions 19 of the disk portions 21 may be provided in the form of an insertion hole 23 penetrating the disk portion 21, as shown, or in the form of an insertion groove (not shown) that is locally recessed in the disk portion 21.

When the insertion portions 19 are provided in the form of insertion grooves, the permanent magnets 9 are not exposed to the surface of the retainer 11. Thus, it is relatively advantageous to prevent unnecessary resistance, noise, and vibration from occurring when the retainer 11 rotates at high speed.

On the other hand, when the insertion portions 19 are provided in the form of insertion holes, manufacturing and assembling of the retainer 11 may be easier.

The motor structure of the present disclosure as described above may be implemented as follows.

The motor structure of the present disclosure includes: a stator 3; a rotor core 13 rotatably inserted into the stator 3; a plurality of permanent magnets 9 inserted parallel to the rotation axis of the rotor core 13; and a retainer 11 that secures an end of the rotor core 13 from which the permanent magnets 9 protrude.

The retainer 11 is configured to restrain the permanent magnets 9 from moving in the radial direction with respect to the rotor core 13.

The permanent magnets 9 are disposed along the circumferential direction of the rotor core 13. The retainer 11 may be provided in a disk shape such that end portions of the permanent magnets 9 are inserted at an end of the rotor core 13.

The permanent magnets 9 may be inserted so as to protrude from opposite ends of the rotor core 13. A retainer 11 may thus be installed at each opposite end of the rotor core 13.

The retainer 11 may be provided with a plurality of insertion holes 23 into which the end portions of the permanent magnets 9 are inserted. Alternatively, the retainer 11 may be provided with a plurality of insertion grooves on the surface facing the rotor core 13 into which the end portions of the permanent magnets 9 are inserted.

Meanwhile, in the retainer 11, insertion portions into which the end portions of the permanent magnets 9 are inserted may be provided at positions symmetrical to each other about the rotation axis of the rotor core 13 to cancel out centrifugal forces of the permanent magnets 9 provided in the rotor core 13.

Although the present disclosure has been described provided above in relation to specific embodiments shown in the drawings, it should be apparent to those of ordinary skill in the art that the embodiments of the present disclosure may be changed and modified in various ways without departing from the scope of the present disclosure, which is provided in the following claims.

What is claimed is:

1. A motor structure comprising:
a rotor core;
a permanent magnet inserted into the rotor core; and
a first retainer installed to support the permanent magnet in a radial direction of the rotor core.

2. The motor structure of claim 1, wherein the permanent magnet has a first protruding end portion protruding from one end of the rotor core, and wherein the first retainer is installed to restrain and support the first protruding end portion of the permanent magnet.

3. The motor structure of claim 2, wherein a second protruding end portion of the permanent magnet protrudes from an opposite end of the rotor core, wherein a second retainer is provided at the opposite end of the rotor core, and wherein the first and second protruding end portions protrude in an axial direction.

4. The motor structure of claim 2, wherein the first retainer includes a disk-shaped disk portion having insertion portions, and wherein the first protruding end portion of the permanent magnet is installed in the insert portions.

5. The motor structure of claim 4, wherein the insertion portions of the disk portion are provided as insertion holes penetrating the disk portion.

6. The motor structure of claim 4, wherein the insertion portions of the disk portion are provided as insertion grooves that are locally recessed in the disk portion.

7. The motor structure of claim 4, wherein the permanent magnet includes a plurality of permanent magnets, and wherein, in the disk portion of the retainer, the insertion portions are provided at positions such that centrifugal forces of the plurality of permanent magnets provided in the rotor core cancel each other out.

8. A motor structure comprising:
a stator;
a rotor core rotatably inserted into the stator;
permanent magnets inserted parallel to a rotation axis of the rotor core and protruding from one end of the rotor core; and
a retainer that secures the one end of the rotor core.

9. The motor structure of claim 8, wherein the retainer restrains the permanent magnets from moving in a radial direction with respect to the rotor core.

10. The motor structure of claim 9, wherein the permanent magnets are disposed along a circumferential direction of the rotor core, and wherein the retainer is provided in a disk shape such that end portions of the permanent magnets are inserted at the one end of the rotor core.

11. The motor structure of claim 10, wherein the permanent magnets are inserted so as to protrude from the one end and an opposite end of the rotor core, and wherein another retainer is installed at the opposite end of the rotor core.

12. The motor structure of claim 10, wherein the retainer is provided with a plurality of insertion holes, and wherein the end portions of the permanent magnets are respectively inserted into the plurality of insertion holes.

13. The motor structure of claim 10, wherein the retainer is provided with a plurality of insertion grooves on a surface facing the rotor core, and wherein the end portions of the permanent magnets are respectively inserted into the plurality of insertion grooves.

14. The motor structure of claim 10, wherein, in the retainer, the end portions of the permanent magnets are inserted are into insertion portions provided at positions symmetrical to each other about the rotation axis of the rotor core to cancel out centrifugal forces of the permanent magnets provided in the rotor core.
